(19) United States
(12) Patent Application Publication
(10) Pub. No.: US 2026/0270396 A1
(43) Pub. Date: Sep. 10, 2026

(54) WEIGHTED PLANAR AND DC MODES FOR INTRA PREDICTION

(71) Applicant: InterDigital CE Patent Holdings, SAS, Paris (FR)

(72) Inventors: Gagan Bihari RATH, Rennes (FR); Ya CHEN, Rennes (FR); Fabrice LE LÉANNEC, BETTON (FR); Antoine ROBERT, Mézières sur Couesnon (FR)

(21) Appl. No.: 19/471,275

(22) PCT Filed: Mar. 25, 2024
(86) PCT No.: PCT/EP2024/057958

§ 371 Date: Sep. 30, 2025

(30) Foreign Application Priority Data
Apr. 6, 2023 (EP) 23305506.0

(51) Int. Cl. H04N 19/105; H04N 19/159; H04N 19/176

(52) U.S. Cl. CPC H04N 19/105; H04N 19/159; H04N 19/176

(57) ABSTRACT

In one implementation, we propose to improve the PLANAR and DC prediction modes by introducing weights, for example, proportional to the sides of the block. The planar mode prediction is obtained by a weighted combination of the horizontal and vertical interpolations. Similarly, the DC value in the DC prediction mode is obtained as a weighted combination of the DC values computed from the top and the left reference arrays of a target block. When the target block is flat because of a high width to height ratio, or tall because of a high height to width ratio, the proposed methods are expected to produce better predictions than the equal weighted versions.

### TECHNICAL FIELD

The present embodiments generally relate to a method and an apparatus for intra prediction in video encoding and decoding.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

According to an embodiment, a method of video decoding is presented, comprising: obtaining a vertical predictor and a horizontal predictor for a sample in an intra block; obtaining a weighted average of said vertical predictor and said horizontal predictor to form a predictor for said sample, wherein a first weight for said vertical predictor is different from a second weight for said horizontal predictor when forming said weighted average; and predicting decoding said sample based on said predictor for said sample.

According to another embodiment, a method of video encoding is presented, comprising: obtaining a vertical predictor and a horizontal predictor for a sample in an intra block; obtaining a weighted average of said vertical predictor and said horizontal predictor to form a predictor for said sample, wherein a first weight for said vertical predictor is different from a second weight for said horizontal predictor when forming said weighted average; and predicting encoding said sample based on said predictor for said sample.

According to another embodiment, an apparatus is presented, comprising: at least one memory; and one or more processors coupled to said memory, wherein said one or more processors are configured to: obtain a vertical predictor and a horizontal predictor for a sample in an intra block; obtain a weighted average of said vertical predictor and said horizontal predictor to form a predictor for said sample, wherein a first weight for said vertical predictor is different from a second weight for said horizontal predictor when forming said weighted average; and decode said sample based on said predictor for said sample.

According to another embodiment, an apparatus is provided, comprising: at least one memory; and one or more processors coupled to said memory, wherein said one or more processors are configured to: obtain a vertical predictor and a horizontal predictor for a sample in an intra block; obtain a weighted average of said vertical predictor and said horizontal predictor to form a predictor for said sample, wherein a first weight for said vertical predictor is different from a second weight for said horizontal predictor when forming said weighted average; and encode said sample based on said predictor for said sample.

One or more embodiments also provide a computer program comprising instructions which when executed by one or more processors cause the one or more processors to perform the encoding method or decoding method according to any of the embodiments described herein. One or more of the present embodiments also provide a computer readable storage medium having stored thereon instructions for video encoding or decoding according to the methods described herein.

One or more embodiments also provide a computer readable storage medium having stored thereon video data generated according to the methods described above. One or more embodiments also provide a method and apparatus for transmitting or receiving the video data generated according to the methods described herein.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder.

FIG. 3 illustrates a block diagram of an embodiment of a video decoder.

FIG. 4A and FIG. 4B respectively illustrate horizontal and vertical interpolations in PLANAR prediction in VVC.

FIG. 5 illustrates DC prediction in VVC and ECM for different target block shapes.

FIG. 6 illustrates a method of intra prediction with the weighted PLANAR or DC mode, according to an embodiment.

### DETAILED DESCRIPTION

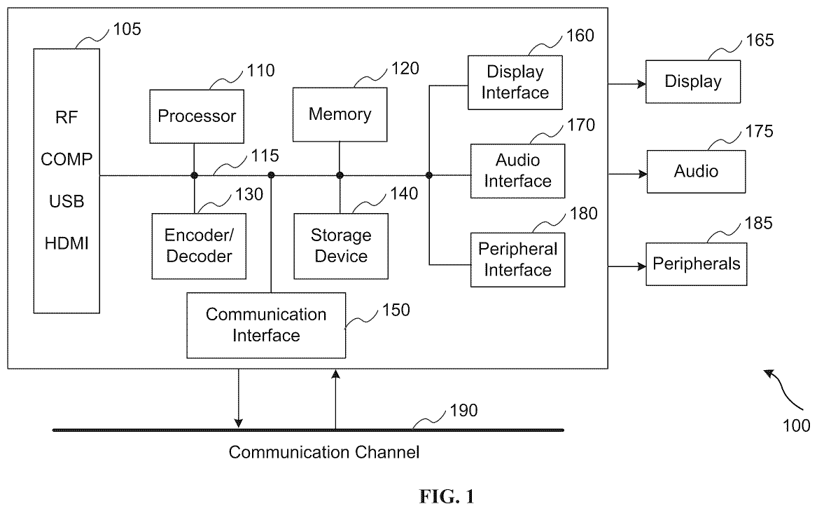

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

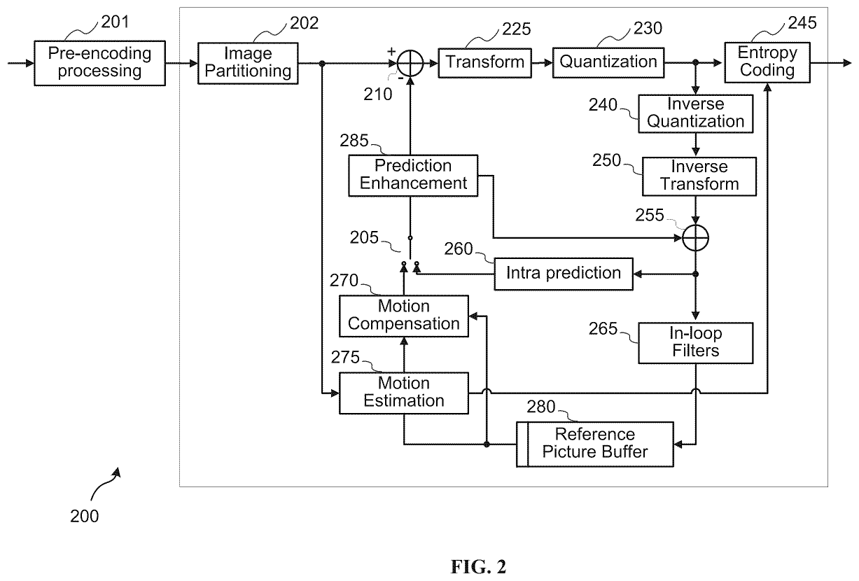

FIG. 2 illustrates an example video encoder 200, such as a a VVC (Versatile Video Coding) encoder. FIG. 2 may also illustrate an encoder in which improvements are made to the VVC standard or an encoder employing technologies similar to VVC.

In the present application, the terms “reconstructed” and “decoded” may be used interchangeably, the terms “encoded” or “coded” may be used interchangeably, and the terms “image,” “picture” and “frame” may be used interchangeably. Usually, but not necessarily, the term “reconstructed” is used at the encoder side while “decoded” is used at the decoder side.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. After prediction, prediction enhancement (285) is applied to the prediction block. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

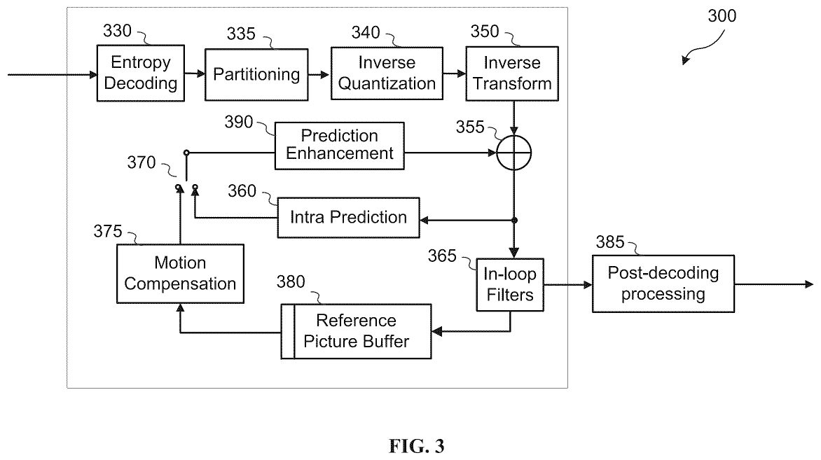

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). After prediction, prediction enhancement (390) is applied to the prediction block. In-loop filters (365) are applied to the reconstructed image. The filtered image is stored at a reference picture buffer (380).

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

In VVC and ECM, encoding of a frame of video sequence is based on a quad-tree (QT)/binary tree (BT)/triple tree (TT) block structure. A frame is divided into non-overlapping square coding tree units (CTUs) which undergo QT/BT/TT based splitting to multiple coding units (CUs) based on rate-distortion criteria. In Intra prediction, a CU is spatially predicted from the causal neighbor CUs, i.e., the decoded CUs on the top and the left, using different prediction modes. Out of the 95 defined modes, one is a planar mode (indexed as mode 0), one is a DC mode (indexed as mode 1) and the remaining 93 (indexed as mode −14, . . . −1, 2, . . . 80) are angular modes. Out of the 93 angular modes, only 65 adjacent modes are selected for any target CU depending on its shape. The planar and DC modes aim to model slowly changing intensity areas whereas the directional modes aim to model directional structures in a frame. It is generally observed that the non-angular modes, especially the planar mode, have the highest probability in an intra frame of a sequence.

The two non-angular modes have been carried on from the HEVC standard except for some slight modifications to adapt to possible rectangular target blocks in VVC and ECM. The planar mode prediction is obtained by taking the average of a horizontal interpolation and a vertical interpolation irrespective of the target block shape. The DC prediction is obtained by using the average value of the reference samples on the longer side of the block. In this document, we propose simple implementable modifications using weighted combinations. Before we describe the proposed methods, we briefly present the planar mode and DC mode predictions as used in VVC and ECM 7.0 in the following. For easier reference, we will be using the terms “CU” and “block” interchangeably throughout the text.

### Planar Mode Prediction in VVC and ECM

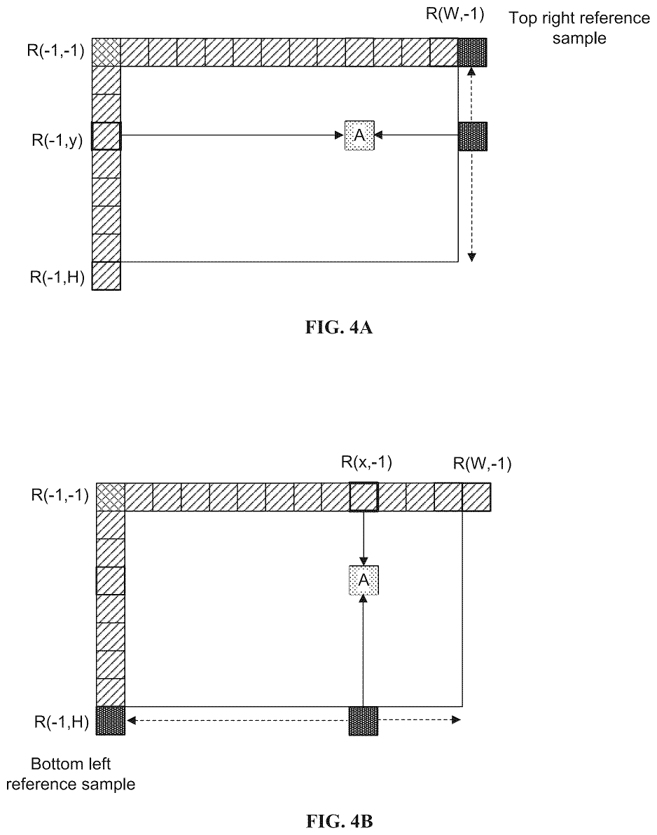

FIG. 4A and FIG. 4B respectively illustrate horizontal and vertical interpolations in PLANAR prediction in VVC. The average value of the two interpolations gives the first prediction in planar mode. The horizontal and vertical interpolations also constitute the horizontal PLANAR and vertical PLANAR in ECM.

The planar prediction is constructed using the average of a horizontal and a vertical interpolation, as shown in FIG. 4A and FIG. 4B. In the horizontal interpolation as shown in FIG. 4A, a pixel value on row y is linearly interpolated using the left reference sample R(−1,y) and the top-right reference sample R(W,−1) at (W,−1), where W denotes the target block width. Similarly, in the vertical interpolation as shown in FIG. 4B, a pixel value on column x is linearly interpolated using the top reference sample R(x,−1) and the bottom-left reference sample R(−1,H) at (−1,H), where H denotes the target block height. The average of these two interpolations makes the first prediction in planar mode. In this document, the calculations are based on integer implementations. It should be noted other forms of integer implementations (e.g., at other precisions) than what is used are also possible. The vertical predictor Pᵥ(x,y) (vertical interpolation), horizontal predictor Pₕ (x,y) (horizontal interpolation), and the planar predictor P(x,y) can be expressed as:

$${P}_{v} ( x , y ) = ( ( H - 1 - y ) * R ( x , - 1 ) + ( y + 1 ) * R ( - 1 , H ) + ( H ≫ 1 ) ) ≫ {log}_{2} H \qquad ( 1 )$$

$${P}_{h} ( x , y ) = ( ( W - 1 - x ) * R ( - 1 , y ) + ( x + 1 ) * R ( W , - 1 ) + ( W ≫ 1 ) ) ≫ {log}_{2} W \qquad ( 2 )$$

$$P ( x , y ) = ( {P}_{v} ( x , y ) + {P}_{h} ( x , y ) ) ≫ 1 \qquad ( 3 )$$

Alternatively, the planar predictor can be calculated as:

$$P ( x , y ) = ( ( {P}_{v}^{′} ( x , y ) ≪ {log}_{2} W ) + ( {P}_{h}^{′} ( x , y ) ≪ {log}_{2} H ) + W * H ) ≫ ( {log}_{2} W + {log}_{2} H + 1 )$$

$$where {P}_{v}^{′} ( x , y ) = ( H - 1 - y ) * R ( x , - 1 ) + ( y + 1 ) * R ( - 1 , H ) ,$$

$${P}_{h}^{′} ( x , y ) = ( W - 1 - x ) * R ( - 1 , y ) + ( x + 1 ) * R ( W , - 1 ) .$$

Subsequently, the predicted values as shown in Eq. (3) are processed with PDPC to smooth out the discontinuities with the top and left reference arrays:

$$P ( x , y ) = ( {w}_{L} * R ( - 1 , y ) + {w}_{T} * R ( x , - 1 ) + ( 64 - {w}_{L} - {w}_{T} ) * P ( x , y ) + 32 ) ≫ 6 \qquad ( 4 )$$

$$where {w}_{T} = 32 ≫ ( ( y ≪ 1 ) ≫ scale ) ,$$

$${w}_{L} = 32 ≫ ( ( x ≪ 1 ) ≫ scale ) ,$$

$$scale = ( {log}_{2} ( W ) + {log}_{2} ( H ) - 2 ) ≫ 2.$$

Since the weights w_{T} and w_{L} are decreasing functions of y and x, respectively, only a few rows at the top and a few columns on the left of the block are affected by the PDPC process depending on the scale value. The remaining values remain unchanged as in the first prediction step.

In ECM, the horizontal and vertical interpolations have also been adopted as horizontal PLANAR and vertical PLANAR modes. Normalizing the interpolations given above, they are derived as:

$$P ( x , y ) = ( ( H - 1 - y ) * R ( x , - 1 ) + ( y + 1 ) * R ( - 1 , H ) + H / 2 ) ≫ {log}_{2} H , for vertical planar \qquad ( 5 )$$

$$P ( x , y ) = ( ( W - 1 - x ) * R ( - 1 , y ) + ( x + 1 ) * R ( W , - 1 ) + W / 2 ) ≫ {log}_{2} W , for horizontal planar \qquad ( 6 )$$

Like the normal planar, the first predicted values are subsequently processed with PDPC in the same manner as given above.

### DC Mode Prediction in VVC and ECM

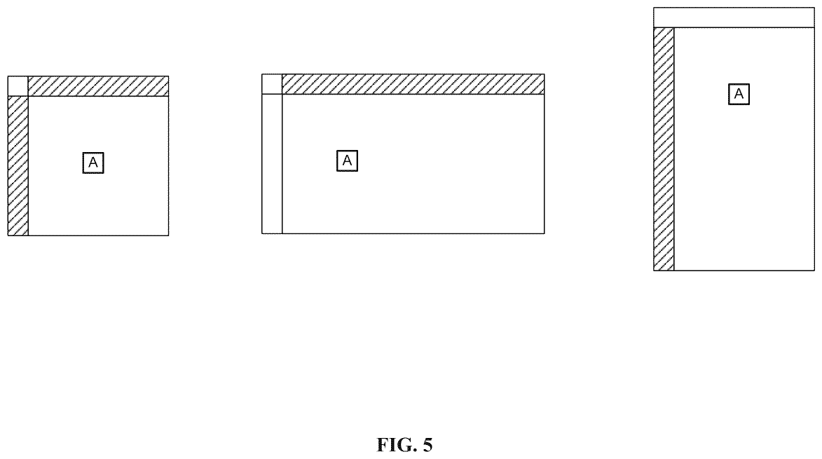

FIG. 5 illustrates DC prediction in VVC and ECM for different target block shapes. The initial prediction value at any pixel is the average value of the shaded reference pixels.

The DC prediction, as shown in FIG. 5 is constructed using the average value of either the top or the left reference samples, or both, depending on the block shape. If the block is of square shape, the average of both the top reference samples and the left reference samples, excluding the top-left corner pixel at (−1, −1), is used as the first prediction for all target pixels. If the block is flat, that is, W>H, the average of the top reference samples with co-ordinates from (0, −1) to (W−1, −1) is used as the first predictor. Similarly, if the block is tall, that is, W<H, the average of the left reference samples with co-ordinates from (−1, 0) to (−1, H−1) is used as the first predictor. Note that the top-right reference samples (on the top reference array) and the bottom-left reference samples (on the left reference array) are excluded from the DC value computation. Mathematically, the first prediction value can be expressed as:

$$P ( x , y ) = \{ \begin{matrix}( {\sum }_{x = 0}^{W - 1} R ( x , - 1 ) + W / 2 ) ≫ {log}_{2} W , if W > H \\ ( {\sum }_{y = 0}^{H - 1} R ( - 1 , y ) + H / 2 ) ≫ {log}_{2} H , if W < H \\ ( {\sum }_{x = 0}^{W - 1} R ( x , - 1 ) + {\sum }_{y = 0}^{W - 1} R ( - 1 , y ) + W ) ≫ ( {log}_{2} 2 W ) , if W = H .\end{matrix}$$

Subsequently, the first predicted values are processed with PDPC to smooth out the discontinuities with the top and left reference arrays in the same manner as done in the case of planar mode.

### Weighted Planar Mode Prediction

As described above, in VVC, the planar mode prediction is an average of two interpolations. Equivalently, each interpolation is given a weight of 0.5 in the combination to derive the final prediction. In ECM, in addition to this, there are also horizontal PLANAR and vertical PLANAR modes, which can be understood as giving a weight of 1 to one interpolation and 0 to the other. In this document, we propose a weighted planar mode, where in an example the weights are derived based on the target block shape.

In the first method, the vertical and the horizontal interpolations are obtained as in vertical and horizontal PLANAR modes:

$${P}_{v} ( x , y ) = ( ( H - 1 - y ) * R ( x , - 1 ) + ( y + 1 ) * R ( - 1 , H ) + H / 2 ) ≫ {log}_{2} H \qquad ( 8 )$$

$${P}_{h} ( x , y ) = ( ( W - 1 - x ) * R ( - 1 , y ) + ( x + 1 ) * R ( W , - 1 ) + W / 2 ) ≫ {log}_{2} W \qquad ( 9 )$$

Then they are combined as follows:

$$P ( x , y ) = \{ \begin{matrix}{P}_{h} ( x , y ) + ( ( wP * ( {P}_{v} ( x , y ) - {P}_{h} ( x , y ) ) + 32 ) ≫ 6 ) , if W \geq H \\ {P}_{v} ( x , y ) + ( ( wP * ( {P}_{h} ( x , y ) - {P}_{v} ( x , y ) ) + 32 ) ≫ 6 ) , if W < H .\end{matrix} \qquad ( 10 )$$

where the weighting parameter wP is determined as

$$wP = \{ \begin{matrix}32 ≫ ( ( {log}_{2} W - {log}_{2} H ) ≫ 1 ) , if W \geq H \\ 32 ≫ ( ( {log}_{2} H - {log}_{2} W ) ≫ 1 ) , if W < H\end{matrix} \qquad ( 11 )$$

In the above combination, the horizontal interpolation is given a higher weight than the vertical one for flat rectangular blocks and the other way around for the tall rectangular blocks. Alternatively, they can be combined as:

$$P ( x , y ) = \{ \begin{matrix}{P}_{v} ( x , y ) + ( ( wP * ( {P}_{h} ( x , y ) - {P}_{v} ( x , y ) ) + 32 ) ≫ 6 ) , if W \geq H \\ {P}_{h} ( x , y ) + ( ( wP * ( {P}_{v} ( x , y ) - {P}_{h} ( x , y ) ) + 32 ) ≫ 6 ) , if W < H .\end{matrix} \qquad ( 12 )$$

where the weighting is done in the opposite way.

In another variation, the horizontal interpolation can be combined with the strictly vertical mode (R(x,−1) is the predictor) and the vertical interpolation can be combined with the strictly horizontal mode (R(−1,y) is the predictor) as follows:

$$P ( x , y ) = \{ \begin{matrix}{P}_{h} ( x , y ) + ( ( wP * ( R ( x , - 1 ) - {P}_{h} ( x , y ) ) + 32 ) ≫ 6 ) , if W \geq H \\ {P}_{v} ( x , y ) + ( ( wP * ( R ( - 1 , y ) - {P}_{v} ( x , y ) ) + 32 ) ≫ 6 ) , if W < H .\end{matrix}$$

Or, alternatively as:

$$P ( x , y ) = \{ \begin{matrix}{P}_{v} ( x , y ) + ( ( wP * ( R ( - 1 , y ) - {P}_{v} ( x , y ) ) + 32 ) ≫ 6 ) , if W \geq H \\ {P}_{h} ( x , y ) + ( ( wP * ( R ( x , - 1 ) - {P}_{h} ( x , y ) ) + 32 ) ≫ 6 ) , if W < H .\end{matrix}$$

In a special case, using equal weighting, two different versions of PLANAR mode can be obtained by averaging the horizontal interpolation and the strictly vertical mode, or by averaging the vertical interpolation and the strictly horizontal mode.

Note that it is possible to combine the normalization with the scaling in these equations, leading to only one rounding. For a square target block, as wP=32, this method becomes equivalent to the normal PLANAR mode.

The weighting parameter wP here is a function of the aspect ratio of the target block. In a variation, it can be determined from the mean absolute difference (MAD) scores computed at the top and left reference arrays after linear interpolation between the top-left and the top-right reference pixels and between the top-left and the bottom-left reference pixels, respectively.

Furthermore, the weighting parameter wP is a fixed value for the entire target block. In a variation, it can be chosen to vary depending on the (x,y) co-ordinates of target pixels.

In another variation, the weighting parameter wP can be selected from a list of values depending on the aspect ratio of the target block using templates as done in TIMD. Planar predictions for a template with each wP are subtracted from the template pixels values and the SATD of the residuals are computed. The wP value giving the minimum SATD value is chosen for the weighted planar prediction of the current block.

In another variation, if the left neighbor block is unavailable but the top neighbor block is available, then the horizontal interpolation can be assigned a weight of 0 and the vertical interpolation can be assigned a weight of 1. In this case, the prediction is equivalent to the vertical planar mode. Similarly, if the top neighbor block is unavailable but the left neighbor block is available, then the vertical interpolation can be assigned a weight of 0 and the horizontal interpolation can be assigned a weight of 1. In this case, the prediction is equivalent to the horizontal planar mode.

More generally, the weighting parameter wP can adapt to the block width and height, and/or can adapt to the decoded samples in the left and top of the block.

As in the normal planar, the initial prediction can be subsequently followed by PDPC.

### Weighted DC Mode Prediction

Irrespective of the block shape, first we derive the DC values of top and left reference samples as the average of the top reference samples and the average of the left reference samples, respectively. The horizontal predictor horDC (DC value of top reference samples) and the vertical predictor verDC (DC value of left reference samples) can be calculated as:

$$horDC = ( {\sum }_{x = 0}^{W - 1} R ( x , - 1 ) + W / 2 ) ≫ {log}_{2} W \qquad ( 13 )$$

$$verDC = ( {\sum }_{y = 0}^{H - 1} R ( - 1 , y ) + H / 2 ) ≫ {log}_{2} H \qquad ( 14 )$$

The final DC value for prediction is obtained as a weighted combination of these two DC values:

$$P ( x , y ) = \{ \begin{matrix}horDC + ( wP * ( verDC - horDC ) + 32 ) ≫ 6 ) , if W \geq H \\ verDC + ( wP * ( horDC - verDC ) + 32 ) ≫ 6 ) , if W < H .\end{matrix} \qquad ( 15 )$$

where the weighting parameter wP is, for example, derived as:

$$w P = \{ \begin{matrix}32 ≫ ( {log}_{2} W - {log}_{2} H ) , if W \geq H \\ 32 ≫ ( {log}_{2} H - {log}_{2} W ) , if W < H\end{matrix} \qquad ( 16 )$$

For a square block, wP=32, and this becomes equivalent to the existing DC prediction. As in the case of weighted PLANAR, it is possible to combine the two rounding operations into only one operation.

The weighting parameter wP here is a function of the aspect ratio of the target block. In a variation, it can be determined from the mean absolute difference (MAD) scores computed at the top and left reference arrays after linear interpolation between the top-left and the top-right reference pixels and between the top-left and the bottom-left reference pixels, respectively.

In another variation, fixed weights can be assigned to the two DC values. For example, when W>2H or H>2 W, we can set wP=16. In the first case, the top DC gets a weight of % and the left DC gets a weight of 14, and in the second case it is vice versa.

In another variation, the weighting parameter wP can be selected from a list of values depending on the aspect ratio of the target block using templates as done in TIMD. DC predictions for a template with each wP are subtracted from the template pixels values and the SATD of the residuals are computed. The wP value giving the minimum SATD value is chosen for the weighted DC prediction of the current block.

In another variation, if the left neighbor block is unavailable but the top neighbor block is available, then the horizontal DC value horDC can be assigned a weight of 1 and the vertical DC value verDC can be assigned a weight of 0. Similarly, if the top neighbor block is unavailable but the left neighbor block is available, then the vertical DC value can be assigned a weight of 1 and the horizontal DC value can be assigned a weight of 0.

More generally, the weighting parameter wP can adapt to the block width and height, and/or can adapt to the decoded samples in the left and top of the block.

The initial prediction can be subsequently followed by PDPC to arrive at the final prediction.

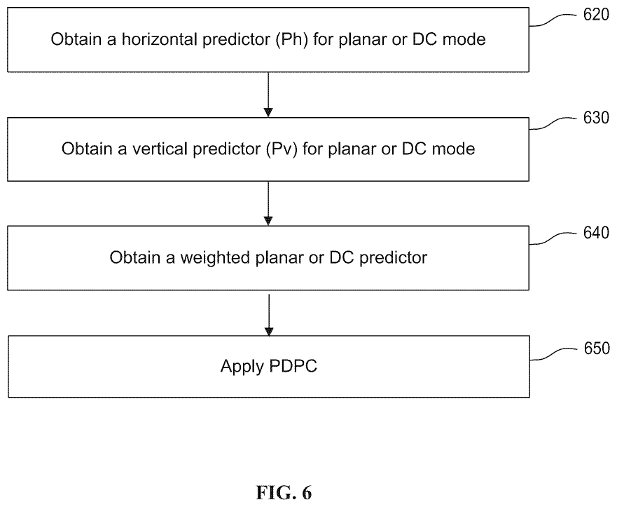

FIG. 6 illustrates a method of intra prediction with the weighted PLANAR or DC mode, according to an embodiment. This method can be used at both the encoder and decoder. In particular, the encoder or decoder calculates (620) the horizontal predictor for the PLANAR or DC mode, as in Eq. (9) or (13), and/or calculates (630) the vertical predictor for the PLANAR or DC mode, as in Eq. (8) or (14). Then a weighted planar or DC predictor is calculated (640), based on the vertical and/or horizontal predictors. PDPC can be applied (650) to get the final prediction.

In a video codec, e.g., based on VVC, ECM, etc., the encoder and the decoder can follow the above weighted prediction for the planar and DC modes. In a variation, the encoder can use the classical planar and DC prediction, and the decoder, including the decoder at the encoder, can use the weighted prediction, or vice versa.

In the following, we assume a video codec that includes intra prediction with block-based CU partitions and various angular and non-angular prediction modes, such as a codec based on HEVC, VVC, or ECM standard, etc.

In one embodiment, we replace the existing PLANAR and/or DC intra prediction mode with the proposed weighted planar/DC mode. The horizontal and vertical interpolations in PLANAR, or the horizontal and vertical DCs in DC prediction, are combined with variable weights where the weights are derived based on the target block width and height.

In another embodiment, the proposed weighted PLANAR/DC mode is included as a new prediction mode in addition to the existing PLANAR/DC mode. The horizontal and vertical interpolations in PLANAR, or the horizontal and vertical DCs in DC prediction, are combined with variable weights where the weights are derived based on the target block width and height. The signaling of the new mode is done explicitly.

In another embodiment, the signaling of the new mode is not done explicitly. Both the encoder and the decoder use templates as used in TIMD to decide between the normal PLANAR/DC and the weighted PLANAR/DC.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules, for example, the intra prediction modules (260, 360), of a video encoder 200 and decoder 300 as shown in FIG. 2 and FIG. 3. Moreover, the present aspects are not limited to VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method of video decoding, comprising:
obtaining a vertical predictor and a horizontal predictor for a sample in an intra block;
obtaining a weighted average of said vertical predictor and said horizontal predictor to form a predictor for said sample, wherein a first weight for said vertical predictor is different from a second weight for said horizontal predictor when forming said weighted average; and
decoding said sample based on said predictor for said sample.

2-6. (canceled)

7. The method of claim 1, wherein said first and second weights are based on a width and a height of said intra block.

8. The method of claim 7, wherein said first and second weights are based on an aspect ratio of said intra block.

9. The method of claim 1, wherein said first and second weights are based on values of top reference samples and left reference samples.

10. The method of claim 1, wherein said first and second weights are based on a difference between (1) a linear interpolation of a top-left reference sample and a top-right reference sample and (2) a linear interpolation of said top-left reference sample and a bottom-left reference sample.

11. The method of claim 1, wherein said first and second weights are based on the availability of decoded neighbor blocks on the left and on the top of the intra block.

12. The method of claim 1, wherein said first and second weights are pre-fixed based on an aspect ratio of said intra block.

13. The method of claim 1, wherein said first and second weights are chosen from a list of weights based on an aspect ratio of said intra block, wherein templates are used to select a best pair of weights from said list.

14-21. (canceled)

22. A method of video encoding, comprising:
obtaining a vertical predictor and a horizontal predictor for a sample in an intra block;
obtaining a weighted average of said vertical predictor and said horizontal predictor to form a predictor for said sample, wherein a first weight for said vertical predictor is different from a second weight for said horizontal predictor when forming said weighted average; and
encoding said sample based on said predictor for said sample.

23. The method of claim 22, wherein said first and second weights are based on values of top reference samples and left reference samples.

24. The method of claim 22, wherein said first and second weights are based on a difference between (1) a linear interpolation of a top-left reference sample and a top-right reference sample and (2) a linear interpolation of said top-left reference sample and a bottom-left reference sample.

25. The method of claim 22, wherein said first and second weights are based on the availability of decoded neighbor blocks on the left and on the top of said intra block.

26. The method of claim 22, wherein said first and second weights are pre-fixed based on an aspect ratio of said intra block.

27. The method of claim 22, wherein said first and second weights are chosen from a list of weights based on an aspect ratio of said intra block, wherein templates are used to select a best pair of weights from said list.

28. An apparatus, comprising:
at least one memory; and
one or more processors coupled to said memory, wherein said one or more processors are configured to:
obtain a vertical predictor and a horizontal predictor for a sample in an intra block;
obtain a weighted average of said vertical predictor and said horizontal predictor to form a predictor for said sample, wherein a first weight for said vertical predictor is different from a second weight for said horizontal predictor when forming said weighted average; and
decode said sample based on said predictor for said sample.

29. The apparatus of claim 28, wherein said first and second weights are based on a difference between (1) a linear interpolation of a top-left reference sample and a top-right reference sample and (2) a linear interpolation of said top-left reference sample and a bottom-left reference sample.

30. The apparatus of claim 28, wherein said first and second weights are based on the availability of decoded neighbor blocks on the left and on the top of said intra block.

31. An apparatus, comprising:
at least one memory; and
one or more processors coupled to said memory, wherein said one or more processors are configured to:
obtain a vertical predictor and a horizontal predictor for a sample in an intra block;
obtain a weighted average of said vertical predictor and said horizontal predictor to form a predictor for said sample, wherein a first weight for said vertical predictor is different from a second weight for said horizontal predictor when forming said weighted average; and
encode said sample based on said predictor for said sample.

32. The apparatus of claim 31, wherein said first and second weights are based on a difference between (1) a linear interpolation of a top-left reference sample and a top-right reference sample and (2) a linear interpolation of said top-left reference sample and a bottom-left reference sample.

33. The apparatus of claim 31, wherein said first and second weights are based on the availability of decoded neighbor blocks on the left and on the top of said intra block.
